(19) United States
(12) Patent Application Publication
(10) Pub. No.: US 2025/0145409 A1
(43) Pub. Date: May 8, 2025

(54) ELEVATOR RUN PROFILE ADAPTATION METHOD

(71) Applicant: Otis Elevator Company, Farmington, CT (US)

(72) Inventor: Uwe Schönauer, Berlin (DE)

(21) Appl. No.: 18/933,393

(22) Filed: Oct. 31, 2024

(30) Foreign Application Priority Data
Nov. 7, 2023 (EP) 23208385.7

(51) Int. Cl. B66B 1/28; B66B 1/30

(52) U.S. Cl. CPC B66B 1/285; B66B 1/304

(57) ABSTRACT

An elevator system includes an elevator car and a drive unit. The elevator system also includes one or more power sources for providing power to the drive unit, a current sensor and a controller. The controller is configured to cause the current sensor to measure a current through the motor while the elevator car is held stationary at the landing by the motor and/or during an initial phase of the run profile, to determine an available power from the one or more power sources, and to determine a predicted power demand for the drive unit based on the measured current and one or more parameters of the predetermined run profile. The controller is also configured to determine whether the predicted power demand is greater than the available power from the one or more power sources.

### FOREIGN PRIORITY

This application claims priority to European Patent Application No. 23208385.7, filed Nov. 7, 2023, and all the benefits accruing therefrom under 35 U.S.C. § 119, the contents of which in its entirety are herein incorporated by reference.

### TECHNICAL FIELD OF INVENTION

This disclosure relates generally to an elevator system and a method of operating an elevator system, and more particularly, but not exclusively, to a method of adjusting run profile parameters of an elevator car based on power availability in the elevator system.

### BACKGROUND OF THE INVENTION

Conventional elevator systems are powered using a three-phase power supply from a local electrical grid. In such systems, the power available from the grid typically exceeds that required by the elevator system in any given state. A maximum power limit is therefore set based on the electrical ratings of the components in the elevator system, for example the maximum current limit of a drive unit of the elevator system, rather than being based on the power available to the system from the power supply. In operation of this kind of system, power to the elevator system is only dependent on whether the grid to which the system is connected is operational.

In the event that power is not available from the grid, the power drawn by the elevator system is greater than the available power from the grid to which it is connected. If an elevator car of the system is being driven to move when this occurs, the motor driving the elevator car stops functioning, and the elevator car is made to perform an emergency stop to ensure the safety of any passengers within the elevator car.

An example of this is illustrated in FIGS. 1a-1c, which shows a plot in FIG. 1b of available power for use by a drive unit of an elevator system against time, alongside a plot, in FIG. 1a of elevator car speed as measured by an encoder, and a plot in FIG. 1c of the acceleration applied to the elevator car by the drive unit to achieve the predetermined run profile seen in FIG. 1a. Each of FIGS. 1a-1c is shown for a time range covering an acceleration of the elevator car from a stationary position at a landing at a time t0, and the subsequent motion of the elevator car until a power loss event occurs at a time tPL.

As can be seen in FIGS. 1a-1c, prior to the power loss event occurring at time tPL, the elevator car is made to accelerate based in an initial phase of the run profile (between t0 and t1), until the car reaches a target speed vi. The elevator car continues to move at the target speed vi until the power loss occurs at time tPL. At this time, the measured velocity of the elevator car can be seen to reduce from vi to zero as the elevator car is made to perform an emergency stop in response to the power loss event. It should be noted that no deceleration is seen in FIG. 1c at time tPL, as this shows the acceleration applied to the elevator car by the drive unit, rather than a measured acceleration of the elevator car.

In contrast to the three-phase power supply described above, some elevator systems are powered using a single-phase power supply received from a local electrical grid, supplemented with a battery connected to the elevator system. This kind of elevator system may be implemented in areas where the local electrical grid is unreliable, as the provision of a battery allows the system to remain functional even when the grid is not operational, for example during a power blackout. Unlike in more conventional three-phase elevator systems, the maximum power limit in single-phase, battery-supplemented systems is set based on the available power from the electrical grid and battery at any given time. In operation, the amount of power consumed by the elevator system, and more particularly the drive unit, may therefore be adjusted based on the level of available power.

For example, when power from the grid is not available, the system may switch to battery-only operation, and the maximum power consumed by the system may be reduced, e.g., by reducing the speed at which the elevator car is driven to move by the drive unit. In this way, if power from the grid is lost, emergency stopping can be avoided by, e.g., moving the elevator car at a lower speed using power from the battery only.

Although it is known to adjust the operating speed of an elevator car in response to a partial loss of power, existing approaches are not well optimised, and typically lead to unnecessarily increased flight times for the elevator car when the maximum power supply is not available. In addition, existing approaches are generally unable to operate when high elevator car loads are present.

The present disclosure aims to provide an improved elevator system and method of operating an elevator system that seeks to address at least some of the above issues.

### SUMMARY OF THE INVENTION

According to a first aspect, there is provided an elevator system comprising; an elevator car; and a drive unit comprising: a drive sheave connected to the elevator car by a tension member; and a motor arranged to rotate the drive sheave so as to the move the elevator car according to a predetermined run profile; wherein the elevator system further comprises: one or more power sources for providing power to the drive unit; a current sensor arranged to measure a current through the motor representative of a torque applied by the motor to the drive sheave; and a controller configured to: cause the current sensor to measure the current through the motor while the elevator car is held stationary at the landing by the motor and/or during an initial phase of the predetermined run profile; determine a predicted power demand for the drive unit based on the measured current and one or more parameters of the predetermined run profile; determine an available power from the one or more power sources; determine whether the predicted power demand is greater than the available power from the one or more power sources; and if the predicted power demand is greater than the available power from the one or more power sources, adjust one or more parameters of the predetermined run profile while the elevator car is held stationary at the landing by the motor and/or during the initial phase.

According to a second aspect, there is provided a method of operating an elevator system comprising an elevator car and a drive unit, the method comprising: measuring a current through a motor of the drive unit using a current sensor while the elevator car is held stationary at the landing by the motor and/or during an initial phase of the predetermined run profile, wherein the current is representative of a torque applied by the motor to a drive sheave connected to the elevator car by a tension member; determining a predicted power demand for the drive unit based on the measured current and one or more parameters of a predetermined run profile for the elevator car; determining an available power from the one or more power sources; determining whether the predicted power demand is greater than the available power from the one or more power sources; and if the predicted power demand is greater than the available power from the one or more power sources, adjusting one or more parameters of the predetermined run profile while the elevator car is held stationary at the landing by the motor and/or during the initial phase.

Thus, it will be seen that in accordance with this disclosure, a predicted power demand for the drive unit of the elevator system is determined based on a current through the motor of the drive unit measured while the elevator car is held stationary at the landing by the motor and/or during an initial phase of the predetermined run profile, representative of a torque applied by the motor to the drive sheave. Based on the measured current, a determination is then made as to whether the predicted power demand is greater than the available power from the one or more power sources providing power to the drive unit, i.e. whether the available power will be exceeded if the elevator car moves according to the predetermined run profile. If the predicted power demand is greater than the available power from the one or more power sources, one or more parameters of the run profile are adjusted during the initial phase of the run profile. It will be understood that the “initial phase” of the run profile may comprise the period of time prior to the elevator car entering a constant speed phase of the run profile. For example, it may comprise a time during which the elevator car accelerates away from the landing until a constant target speed is reached.

By adjusting one or more parameters of the predetermined run profile based on a determination that the available power will be exceeded, the predetermined run profile can be adjusted in advance so as to ensure that the power consumed by the elevator system will not be greater than the available power during the subsequent stages of the run profile. This may allow emergency stopping operations caused by, for example, excessive load in the elevator car or a significant shortage of available power from the one or more power sources to be avoided. For example, the controller may determine from the measured current that the load in the elevator car requires that the speed and/or acceleration of the elevator car be reduced in order to prevent the amount of power used by the drive unit exceeding the available power from the one or more power sources. Thus, in some examples, the controller may be configured to cause the drive unit to move the elevator car according to the adjusted run profile by causing the motor to rotate the drive sheave.

Furthermore, basing the determination that the available power will be exceeded on a current measured while the elevator car is held stationary at the landing by the motor and/or during the initial phase of the run profile means that the parameters of the subsequent stages of the run profile can be adjusted for each individual journey performed by the elevator car, depending on, for example, the load within the elevator car and the direction of the run. This may allow journey times to be reduced in comparison to existing approaches, particularly in the case of low car loads.

In some examples, the controller may be configured to cause the current sensor to measure the current through the motor while the elevator car is held stationary at a landing by the motor, i.e., prior to the car moving away from the landing. When the elevator car is held stationary by the motor, the current through the motor generates a torque that counteracts torque on the drive sheave resulting from the load of the elevator car. Thus, when the current through the motor is measured while the elevator car is held stationary by the motor, the current is representative of the load in the elevator car. The controller may therefore adjust some of the parameters of the predetermined run profile based on the load in the elevator car. In some such examples, the controller may be configured to adjust the one or more parameters of the predetermined run profile while the elevator car is held stationary at the landing by the motor, i.e., before the elevator car leaves the landing. This may ensure that the load in the elevator car is accounted for in the adjusted run profile prior to the power required by the drive unit being increased to move the elevator car away from the landing. This may comprise adjusting the parameters of maximum jerk and/or maximum acceleration in the predetermined run profile before the elevator car leaves the landing.

In some examples, in addition or alternatively, the controller may be configured to adjust the one or more parameters of the run profile during the initial phase of the predetermined run profile. This may comprise adjusting the parameters of maximum jerk and/or maximum acceleration and/or constant target speed in the predetermined run profile while the elevator car is moving during the initial phase.

In some examples, in addition or as an alternative to causing a current value to be measured while the elevator car is stationary at a landing, the controller may be configured to cause the current sensor to measure the current through the motor during an initial phase of the run profile. For example, the controller may be configured to cause the current sensor to measure the current through the motor during the initial phase of the predetermined run profile, i.e. at any time before the elevator car reaches a constant target speed. In some such examples, the controller may be configured to cause the current sensor to measure the current through the motor during an initial acceleration of the elevator car away from the landing. In some further examples, the controller may be configured to cause the current sensor to measure the current through the motor during a reducing acceleration of the elevator car as it approaches the constant target speed.

The controller may be configured to determine the available power for the drive unit based on respective inputs (e.g. an electrical signal, e.g. voltage and/or current) received from the one or more power sources, indicating that the power source from which the input is received is operational. As an example, in the case that the one or more power sources comprises a first power source and a second power source, the controller may receive a first and/or second input from the first power source and second power source respectively indicating that the first power source and/or the second power source is operational. When the controller only receives an input from the first power source, the controller may determine that a first amount of power is available for the drive system. When the controller only receives an input from the second power source, the controller may determine that a second amount of power is available for the drive system. When the controller receives an input from both the first power source and the second power source, the controller may determine that a third amount of power is available for the drive system, e.g. equal to the sum of the first amount of power and the second amount of power. It will be appreciated that although the above example describes a system with two power sources, this is purely exemplary and the number of power sources may be fewer or greater than this in some examples.

When the elevator car is caused to move away from the landing by the motor during the initial phase of the predetermined run profile, the current through the motor generates a torque that counteracts torque on the drive sheave resulting not just from the load in the elevator car but also from the inertia of the elevator car and friction within the elevator hoistway. Thus, measuring the current through the motor while the elevator car moves away from the landing in the initial stage of the predetermined run profile may allow the effects of imbalance, and/or inertia and/or friction to be accounted for when adjusting the parameters of the run profile.

In some examples, the one or more power sources may comprise a source of AC power. In some examples, the source of AC power may comprise a connection to an electrical grid. This connection may be made via a direct connection to the electrical grid (e.g. a 480 V, three-phase line voltage), or may be a connection via a power outlet in the building in which the elevator system is located, e.g. a connection to a 230 V single-phase line voltage.

In addition or as an alternative to a source of AC power, in some examples the one or more power sources may comprise a battery. The use of a battery may allow the elevator system to operate even when power from a local electrical grid is unavailable. The battery may comprise a battery bank comprising a plurality of batteries connected in series. In examples in which the one or more power sources comprises a battery, the system may comprise an inverter for converting the DC power supplied by the battery into a three-phase alternating power for use by the motor. The inverter may be comprised in the drive unit in some examples, for example in a regenerative drive of the drive unit.

In examples in which the elevator system is connected to an electrical grid via a power outlet in the building in which the elevator system is located, the one or more power sources may comprise a single-phase power supply. In such examples, the elevator system may include a converter for converting the single-phase AC power supply to DC power, which may be used for charging a battery of the elevator system in some examples. In some such examples, the elevator system may include an inverter for converting the DC power to three-phase power for powering the motor. The inverter may be comprised in the drive unit in some examples, for example in a regenerative drive of the drive unit.

In some examples the controller may be configured to determine whether the available power from the one or more power sources has reduced by more than a threshold value. For example, the controller may determine that one or more of the one or more power sources is not operational. This may be particularly important in systems in which the one or more power sources comprise a source of AC power, e.g. a connection to an electrical grid, in addition to a battery, as it may indicate that the AC power source and/or the battery is unable to supply power to the elevator system. If a determination is made that the available power has reduced by more than a threshold value, for example prior to the elevator car moving away from the landing, the controller may adjust one or more parameters of the predetermined run profile based on the determination. This adjustment may allow the elevator system to continue to operate even when one of the source of AC power or the battery is not available.

The parameters of the predetermined run profile (referred in the following as run profile parameters) may define the way in which the elevator car is controlled to move between landings. In some examples, the run profile parameters may define one or more of the speed, acceleration and jerk of the elevator car as it moves from a departure landing to a destination landing during a run between landings according to a predetermined run profile.

In some examples, the run profile parameters may define a time-series of speed, acceleration and/or jerk values describing the movement of the elevator car. For example, the run profile parameters may comprise a time-series of speed and/or acceleration and/or jerk values for the elevator car as it moves from a departure landing to a destination landing during a run between landings.

A run between landings by the elevator car may comprise a first “jerk-in” phase, in which the elevator car is made to accelerate from zero acceleration to a predetermined maximum acceleration value, and a first “jerk-out” phase in which the acceleration is reduced from the maximum acceleration value to zero. After the first jerk-out phase, the elevator car may travel at a constant target speed until it is approaching the destination landing. At this point, a second “jerk-in” phase may be initiated, in which the elevator car is made to decelerate from zero deceleration to a predetermined maximum deceleration value. Finally, a second “jerk-out” phase may be initiated, in which deceleration reduces from the maximum deceleration value to zero and the speed of the elevator car may also be reduced to zero such that the car stops at the destination landing.

Thus, in some examples, the one or more parameters of the predetermined run profile may comprise a constant target speed of the elevator car. The constant target speed may be a maximum speed of the elevator car during a run between landings. The constant target speed may be a constant speed of the car after accelerating away from the departure landing and prior to decelerating when approaching a destination landing. In some examples, the controller may be configured to adjust the constant target speed of the elevator car while the elevator car is moving during the initial phase.

In some examples, the one or more parameters of the predetermined run profile may comprise an acceleration of the elevator car. The acceleration may be a maximum acceleration of the elevator car during a run between landings. The controller may be configured to adjust the maximum acceleration of the elevator car while the elevator car is held stationary at the landing by the motor and/or while the elevator car is moving during the initial phase.

In some examples, the one or more parameters of the predetermined run profile may comprise a jerk of the elevator car during a run between landings, e.g. a maximum jerk of the elevator car during a run between landings. The controller may be configured to adjust the maximum jerk of the elevator car while the elevator car is held stationary at the landing by the motor and/or while the elevator car is moving during the initial phase.

In some examples, the controller may be configured to adjust the maximum acceleration and/or the maximum jerk of the elevator car at a first time during the initial phase and to subsequently adjust the constant target speed of the elevator car at a second, later time during the initial phase. The first time may be, for example, during an initial acceleration of the elevator car away from a landing. The second, later time at which the constant target speed may be, for example, during a period of constant acceleration of the elevator car.

In some examples, the run profile parameters may comprise a plurality of time-series of speed, acceleration and/or jerk values. For example, the run profile parameters may comprise respective time series of speed, acceleration and jerk values associated with the different phases of the run profile. In some such examples, the run profile parameters may comprise a time series of jerk values associated with the first “jerk-in” phase, and/or a time series of jerk values associated with the first “jerk-out” phase, and/or a time series of jerk values associated with the second “jerk-in” phase, and/or a time series of jerk values associated with the second “jerk-out” phase. In some examples, the run profile parameters may comprise a first time series of acceleration values for each of the acceleration and deceleration phases of the predetermined run profile.

In some examples, the acceleration and/or jerk parameters may be adjusted while the elevator car is stationary at the landing, and the speed parameter may be adjusted dynamically during the initial phase of the predetermined run profile, e.g., while the elevator car is moving away from a departure landing.

The motor may be a three-phase AC synchronous or asynchronous motor in some examples. However it will be appreciated that in some examples, alternative motor types, such as a single-phase motor could be used.

The controller may be part of an elevator control system in some examples. The controller may comprise a general-purpose processor executing a computer program stored on a storage medium that includes instructions to perform the method of the second aspect. In some examples, the predetermined run profile may be stored in a memory accessible by the controller.

The current through the motor may be measured by the current sensor by detecting the current flowing into or out of the motor from the one or more power sources. In some examples, a Hall effect sensor or a shunt resistor may be used to measure the current through the motor.

Features of any aspect or example described herein may, wherever appropriate, be applied to any other aspect or example described herein. Where reference is made to different examples or sets of examples, it should be understood that these are not necessarily distinct but may overlap.

### BRIEF DESCRIPTION OF THE DRAWINGS

Certain examples of this disclosure will now be described, with reference to the accompanying drawings, in which:

FIGS. 1a, 1b and 1c illustrate the prior art for (a) elevator car speed according to a predetermined run profile, (b) available power, and (c) elevator car acceleration according to the available power and predetermined run profile;

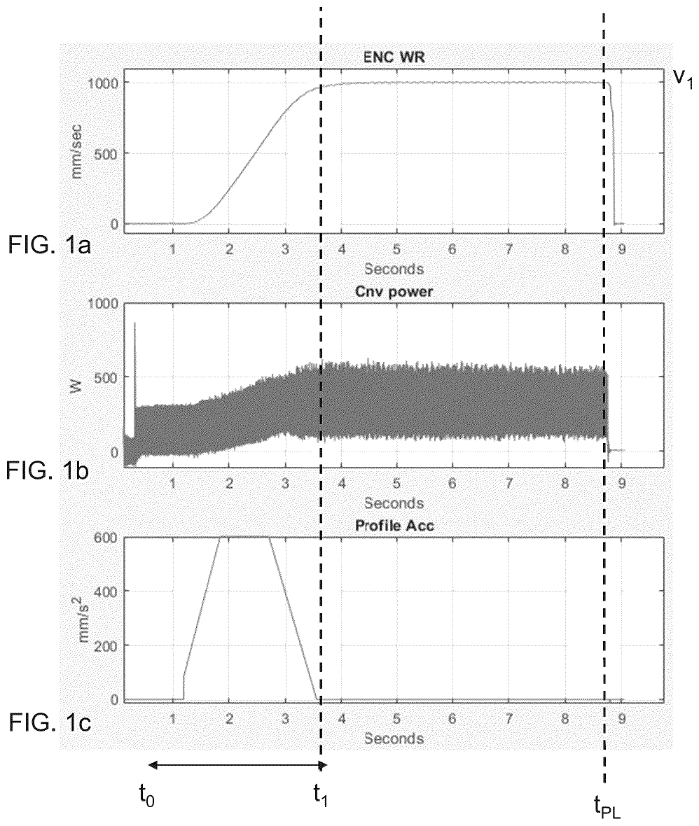

FIG. 2 shows an elevator system according to an example of the present disclosure;

FIG. 3 is a flow diagram illustrating a method of operating an elevator system according to an example of the present disclosure;

FIG. 4 is a flow diagram illustrating a method of operating an elevator system according to an example of the present disclosure;

FIG. 5 shows the power used by the elevator system and the speed of the elevator car for a range of elevator car loads according to a basic approach;

FIG. 6 shows the power used by the elevator system and the speed of the elevator car for a range of elevator car loads when implementing a method of operating an elevator system according to an example of the present disclosure; and

FIGS. 7a-7d show adaptations to parameters of an elevator run profile in an elevator system according to an example of the present disclosure.

### DETAILED DESCRIPTION OF THE INVENTION

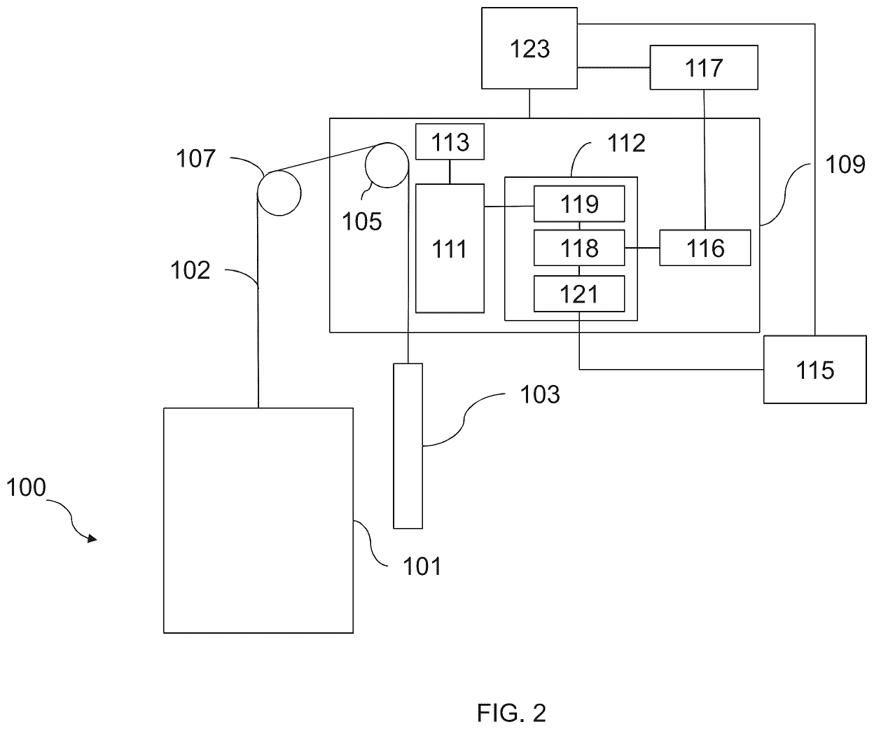

FIG. 2 shows a schematic overview of an elevator system 100 according to an example of the present disclosure. The elevator system 100 includes an elevator car 101 and a counterweight 103 connected by a tension member 102 extending over a drive sheave 105 of a drive unit 109 and a diverter sheave 107 located between the drive sheave 105 and the elevator car 101. The drive unit 109 includes a motor 111 and a regenerative drive 112. A controller 123 is operatively connected to the drive unit 109.

The drive sheave 105 is rotated by a three-phase motor 111 of the drive unit 109 so as to move the tension member 102 and thereby move the elevator car 101 in the hoistway as is known in the art. The drive unit 109 comprises a current sensor 113 configured to measure the current through the motor 111 in use, and a friction brake (not shown in FIG. 2 for simplicity of illustration) that can be used to selectively apply a braking force to resist rotation of the drive sheave 105. This may be performed for one or more reasons, such as due to the load of the elevator car 101. The friction brake may be used to apply a braking force to hold the elevator car 101 at a landing of the building or to slow the movement of the elevator car 101.

The motor 111 is powered using a single-phase power supply 115 as a first power source and a battery 117 as a second power source. In this example, both power sources 115, 117 are connected to the motor 111 via the regenerative drive 112. The single-phase power supply 115 is provided through a connection to a fused outlet in the building in which the elevator system 100 is situated, and is able to provide 2 kW±10% of power to the elevator system 100. The battery 117 comprises a bank of 8 batteries connected in series, each able to provide 1 kW±10% of power to the elevator system 100, provided that the battery 117 is within its normal operating parameters, e.g. when the temperature of the battery 117 is within a predetermined range. This means that the maximum power available to the elevator system 100 is 10 kW±10% when both the battery 117 and the single-phase power supply 115 are fully operational.

To enable the controller 123 to determine the amount of power available to the elevator system 100, in this example the controller 123 is configured to receive an input e.g. current/voltage from each of the battery 117 and the single-phase power supply 115 when they are operational, i.e. able to provide power to the drive system 109. Based on the received input(s) from the battery 117 and/or the single-phase power supply 115, the controller 123 determines the power available to the drive system 109. When only the single-phase power supply 115 is operational, the controller 123 determines that 2 kW±10% of power is available to the drive unit 109. When only the battery 117 is operational, the controller 123 determines that 8 kW±10% of power is available. When both the battery 117 and the single-phase power supply 115 are operational, the controller determines that 10 kW±10% of power is available to the drive unit 109.

In some examples, the controller 123 can be configured to more accurately determine the amount of power available to the elevator system 100 by taking into account one or more external factors. For example, when the battery 117 is outside of the range of its normal operating parameters, e.g., when the temperature of the battery 117 is above/below a limit, the input from the battery 117 to the controller 123 may indicate that the battery is outside of the range of its normal operating parameters, and that the available power is reduced as a result. In this scenario, the controller can determine that a reduced amount of power, e.g. 6 kW±10%, is available to the drive unit 109 from the battery 117.

In order to provide power from the single-phase power supply 115 to the three-phase motor 111 of the drive unit 109, the regenerative drive 112 of the drive system 109 comprises an AC/DC converter 121 which converts single-phase AC power from the single-phase power supply 115 to DC power which is provided to a DC bus 118 of the regenerative drive 112. The DC bus 118 outputs to an inverter 119 which converts DC power from the DC bus 118 to three-phase AC power for the motor 111 of the drive unit 109.

In order to provide power from the battery 117 to the three-phase motor 111 of the drive unit 109, the drive unit 109 includes a DC/DC converter 116 which receives power from the battery 117 as an input, and which outputs to the DC bus 118 of the regenerative drive 112. The DC bus 118 outputs to the inverter 119 which converts DC power from the DC bus 118 to three-phase AC power for the motor 111 of the drive unit 109. The battery 117 can be charged using the single-phase power supply 115 via the DC bus 118 and the DC/DC converter 116. The battery 117 can also be charged using regenerative power from the motor 111 delivered to the battery 117 via the inverter 119, the DC bus 118 and the DC/DC converter 116.

In the elevator system 100 shown in FIG. 2, the available power supply can vary, e.g., depending on grid availability via the single-phase power supply 115 and/or the charge level of the battery 117. For example, if the single-phase power supply 115 becomes unavailable, e.g. during a blackout of the local electrical grid, only 8 kW±10% of power is available to the elevator system 100 via the battery 117.

Similarly, if there is an issue with the battery 117, only 2 kW±10% of power is available to the elevator system 100 from the single-phase power supply 115. When the available power falls by more than a threshold value, e.g. when one of the battery 117 or the single phase power supply 115 is not operational, the controller 123 of the elevator system 100 is configured to adjust the operation of the drive unit 109 to ensure the elevator system 100 remains functional as will be explained in more detail below.

The controller 123 is configured to control movement of the elevator car 101 by providing appropriate instructions to the drive unit 109. More specifically, the controller 123 provides instructions to the drive unit 109 to control the motor 111 to cause the elevator car 101 to move between landings of the building in which the elevator system 100 is situated.

The motor 111 is controlled by the controller 123 to move the elevator car 101 according to a predetermined run profile, e.g., comprising an initial (acceleration) phase, a constant speed phase, and a deceleration phase. Prior to the acceleration phase, the elevator car 101 is held stationary at a landing (e.g. a departure landing). In the acceleration phase, the elevator car is caused to accelerate away from the landing by the motor 111 until it reaches a target speed. After the acceleration phase, the motor 111 causes the elevator car 101 to continue to move at the target speed in the constant speed phase until it approaches a destination landing, at which point the friction brake is applied after the deceleration phase such that the speed of the elevator car 101 is reduced to zero as the elevator car 101 arrives at the destination landing.

The acceleration and speed of the elevator car 101 during the predetermined run profile are defined within the run profile by a set of run profile parameters that can be adjusted based on the power available to the elevator system 100. The run profile parameters include, but are not limited to, acceleration, speed and jerk of the elevator car 101.

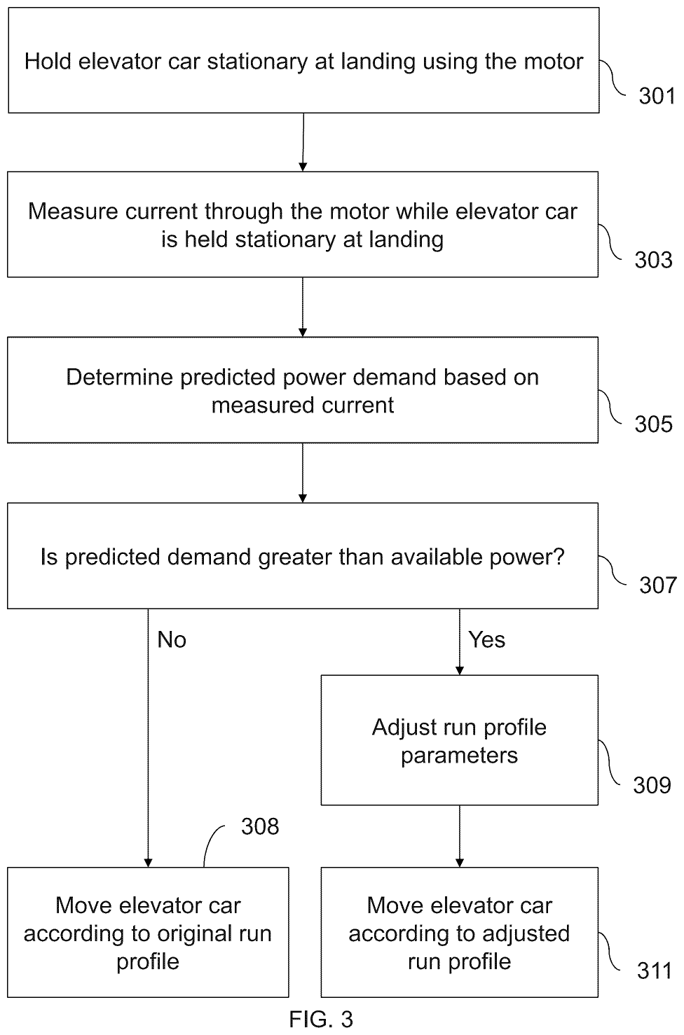

In a first example, the elevator car 100 is moved according to the predetermined run profile parameters as explained below with reference to FIG. 3, which shows a flow diagram illustrating a method of operating the elevator system 100 according to an example of the present disclosure.

In step 301, the elevator car 101 is held at a landing using the motor 111, such that a current flows through the motor 111 so as to generate a torque that counteracts torque on the drive sheave 105 resulting from the load of the elevator car 101.

With the elevator car 101 held stationary at the landing, a current through the motor 111 is measured using the current sensor 113 in step 303. As the current through the motor 111 generates a torque that counteracts torque resulting from the load of the stationary elevator car 101, the measured current is representative of the load in the elevator car 101 while the elevator car 101 is held stationary at the landing.

In step 305, the current measurement is provided to the controller 123, which determines a predicted power demand for the drive unit 109 of the elevator system 100 based on the measured current (and hence the load in the elevator car 101) while the elevator car 101 is held stationary at the landing by the motor.

The controller 123 compares the predicted power demand to the amount of power available to the drive unit 109, as determined from the input(s) received at the controller 123 by the single-phase power supply 115 and the battery 117, in step 307.

If the predicted power demand is less than the power available to the drive unit 109, the process continues to step 308, in which the controller 123 causes the drive unit 109 to move the elevator car 101 according to a standard (e.g. unadjusted) predetermined run profile.

If, however, the predicted power demand is greater than the amount of power available to the drive unit 109 from the battery 117 and the single-phase power supply 115, the process continues to step 309.

In step 309, the controller 123 adjusts one or more parameters of the predetermined run profile while the elevator car 101 is stationary at the landing by the motor 111 so as to reduce the power demand of the drive unit 109 during the elevator run. For example, the controller 123 adjusts one or more of the acceleration, speed or jerk of the elevator car 101 in order to reduce the maximum power demand of the drive unit 109 in the subsequent run.

Once the parameters of the run profile have been adjusted by the controller 123 to reduce the peak power demand of the drive unit 109, the controller 123 causes the drive unit 109 to move the elevator car 101 according to an adjusted run profile in step 311.

By adjusting one or more run profile parameters based on the current through the motor 111 before the elevator car 101 moves away from the departure landing, the peak power consumed by the elevator system 100 (and more particularly by the drive unit 109) can be reduced in advance such it will not be greater than the power available to the elevator system 100 from the single-phase power supply 115 and the battery 117 during the subsequent run. In addition, by determining the predicted power demand based on the current through the motor 111, representative of the motor torque and hence the load in the elevator car 101 while it is held stationary at the landing, the use of less reliable equipment, such as an elevator car weighing system, can be advantageously avoided.

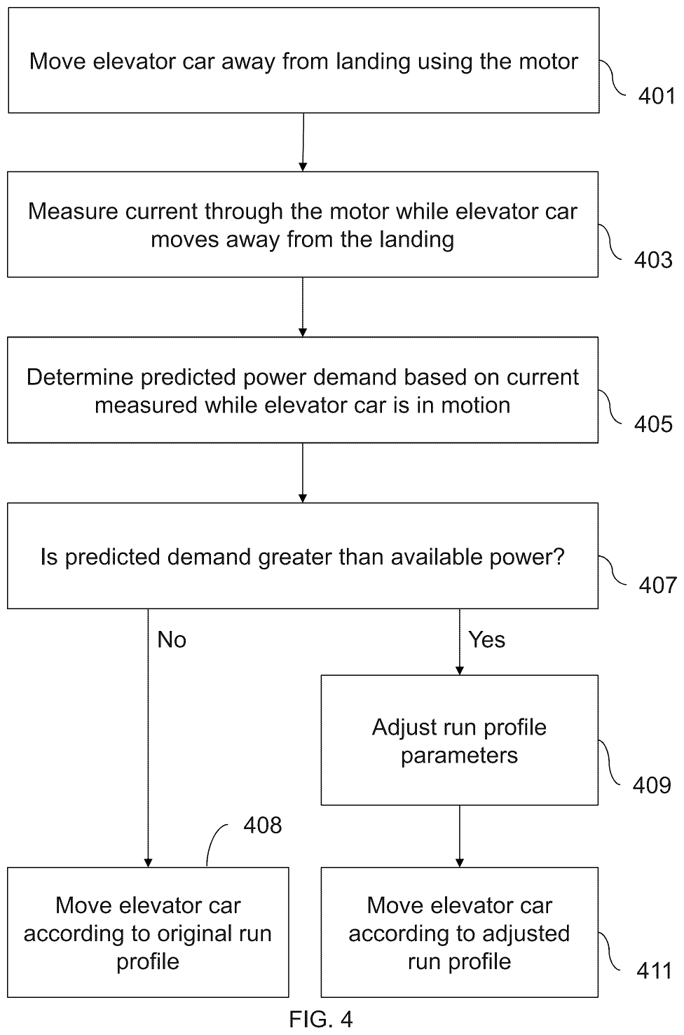

In addition, or as an alternative to, determining whether the run profile parameters need to be adjusted based on a predicted power demand determined from a measured current while the elevator car 101 is held stationary at a landing, the run profile parameters can be adjusted based on a current through the motor 111 measured by the current sensor 113 while the elevator car 101 is in motion. More specifically, the current through the motor 111 can be measured during an initial phase of the predetermined run profile, and adjusted run profile parameters are determined in response to this measured current value. An example of this is illustrated in FIG. 4, which shows a flow diagram illustrating a method of operating the elevator system 100 according to the present disclosure that is performed as the elevator car 101 moves away from the landing during an initial phase of the predetermined run profile.

In step 401, the elevator car 101 is moved away from a departure landing using the motor 111.

As the elevator car 101 accelerates away from the landing, the current through the motor 111 is measured using the current sensor 113 in step 403. As the current through the motor 111 is required to generate a torque that causes the elevator car 101 to accelerate, the measured in-motion current is representative not just of the load in the elevator car 101, but also of the inertia of the elevator car 101 and the friction within the elevator hoistway.

In step 405, the current measurement is provided to the controller 123, which determines a predicted power demand for the drive unit 109 of the elevator system 100 based on the measured current.

The controller 123 compares the predicted power demand to the power available to the drive unit 109, as determined from the input(s) received at the controller 123 by the single-phase power supply 115 and the battery 117, in step 407. If the predicted power demand is less than the power available to the drive unit 109, the process continues to step 408, in which the controller 123 causes the drive unit 109 to move the elevator car 101 according to the run profile set prior to the elevator car 101 leaving the departure landing. If, however, the predicted power demand is greater than the amount of power available to the drive unit 109 from the battery 117 and the single-phase power supply 115, the process continues to step 409.

In step 409, the controller 123 adjusts one or more parameters of the run profile so as to reduce the power demand of the drive unit 109 during the subsequent stages of the run profile. For example, the controller 123 may adjust one or more acceleration, speed or jerk values of the run profile in order to reduce the maximum power demand by the drive unit 109.

Once the parameters of the run profile have been adjusted by the controller 123 to reduce the peak power demand of the drive unit 109, the controller 123 causes the drive unit 109 to move the elevator car 101 according to the adjusted run profile in step 411.

By measuring the current through the motor 111 during an initial phase of the predetermined run profile, for example as the elevator car 101 accelerates away from the departure landing in the initial phase of the run profile, the predicted power demand of the elevator system 100 (and more particularly by the drive unit 109) can be determined more accurately than based solely on measurements performed while the elevator car 101 is held stationary at a landing by the motor 111. Based on this improved prediction, the run profile parameters can be adjusted to achieve improved flight times in comparison with adjustments based solely on measurements performed while the elevator car 101 is held stationary at the landing, while still ensuring that the amount of power consumed by the drive unit 109 does not exceed the available power.

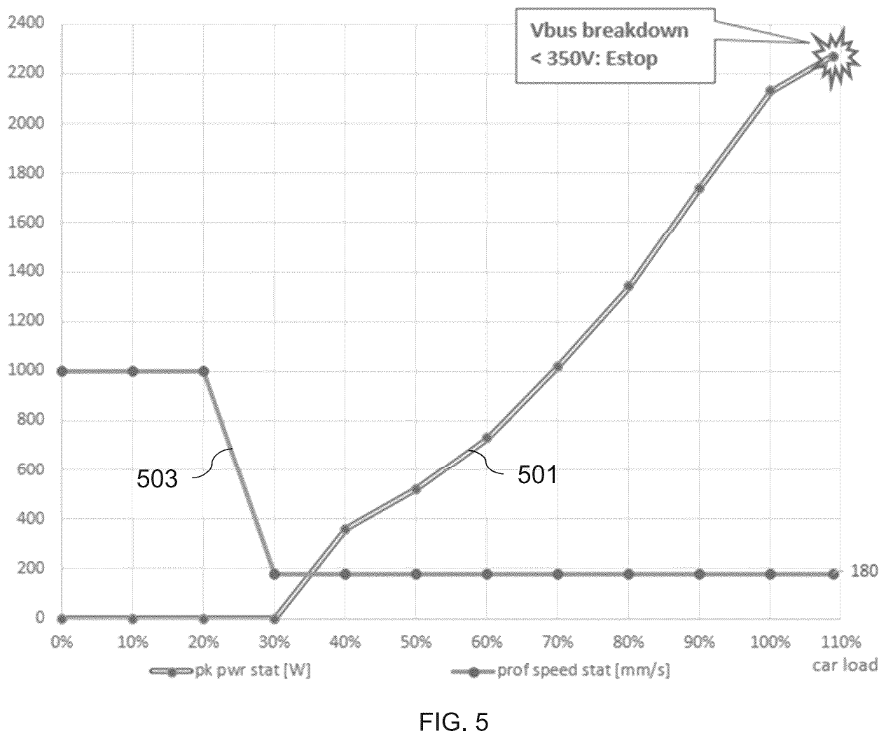

FIG. 5 illustrates the peak power consumed by the drive unit of the elevator system (curve 501) and the speed of the elevator car (curve 503) in the constant speed phase of a predetermined run profile for a range of elevator car loads, for a system in which the run profile parameters are adjusted according to a basic approach used as a benchmark for the present disclosure. More specifically, the run profile parameters are adjusted to a “quasi-static” profile by a simple method which aims at running a full speed profile in regenerative runs and a reduced speed profile in motoring runs above 20% car load. Here, each motoring run is started with a full speed profile (1000 mms-1) but is switched over to the reduced profile (180 mms-1) as soon as the current in the motor 111 indicates a motoring torque is required to drive the elevator car.

In FIG. 5, power is provided to the elevator system 100 solely by the single-phase power supply 115, i.e. the battery 117 is unavailable. Because of this, only 2 kW±10% of power is available to the drive unit 109 of the elevator system 100.

It can be seen that, when the quasi-static run profile is employed, the elevator car 101 is caused to move, in the constant speed phase of the run profile, at 1000 mms−1 for elevator car loads of 20% of maximum load or less. At all times the acceleration is set to 0.2 ms−2 and the jerk is set to 0.2 ms−3 in order to reduce the peak power consumption of the elevator system 100.

For car loads of 30% or higher, the speed of the elevator car 101 in the constant speed phase of the run profile can be seen to be reduced to 180 mms−1 as a result of adjustments to the run profile parameters. In this way the total power required by the elevator system 100 can be reduced such that car loads up to 100% of the maximum car load can be accommodated even in the reduced power scenario shown in FIG. 3. If the parameters of the run profile were not adapted based on the measured car load using the method of the present disclosure, the power demand of the drive unit 109 would exceed the available power for a lower car load, such that the elevator system 100 could only operate for loads up to said lower car load.

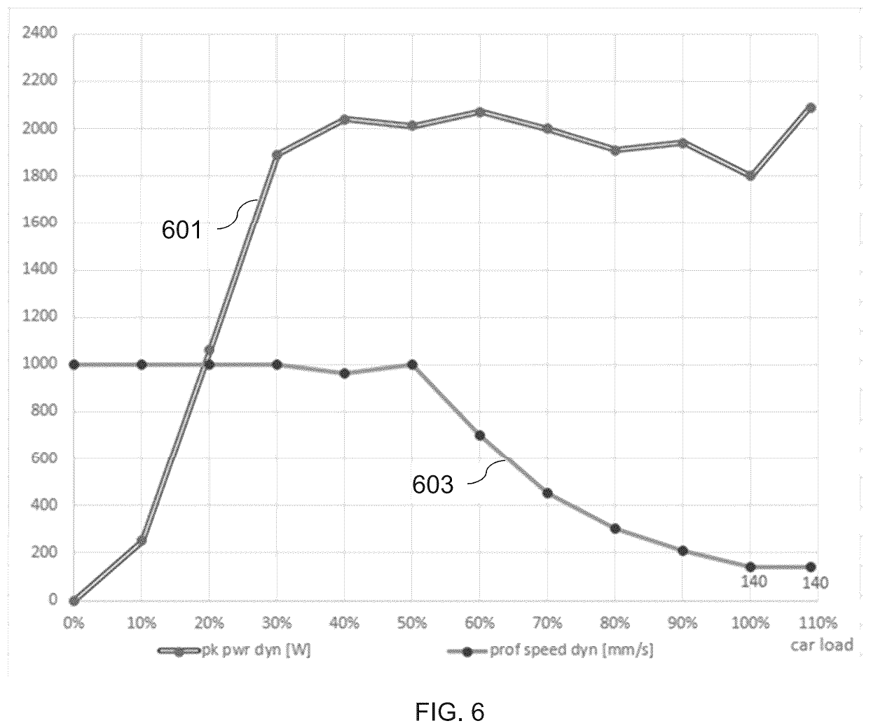

FIG. 6 illustrates the peak power consumed by the drive unit 109 of the elevator system 100 (curve 601) and the resulting speed of the elevator car 101 (curve 603) in the constant speed phase of a run profile for a range of elevator car loads, for a system in which the run profile is adjusted according to the present disclosure. More specifically, in the run profile shown in FIG. 6, the predetermined run profile parameters are adjusted to a “dynamic” profile, in which the elevator system 100 is configured to measure the current through the motor 111 both while the elevator car 101 is held at the landing by the motor 111, as well as during the initial phase of the run profile. More specifically, the current through the motor 111 is also measured during the acceleration of the elevator car 111 away from the landing as described above in relation to FIG. 4. A predicted power demand is thus determined based on the values of the current measured both while the elevator car is stationary at the landing and during the initial phase of the run profile.

Firstly, an estimate of the holding power necessary for the load in the elevator car is made based on the current measured while the elevator car is stationary. Secondly, an estimate of the power needed to generate torque in the motor to move the elevator car in the initial phase of the run profile is then made based on the measured current in the initial phase.

The electrical power required to move the elevator car 101 to the run profile is approximately equal to the mechanical power required to move the elevator car 101. In practice, the electrical power required is greater than the mechanical power due to efficiency losses, which are accounted for using a multiplier when determining the electrical power required to drive the elevator car 101 to the run profile. The mechanical power PM is equal to the product of the torque, τ, applied to the drive sheave 105 multiplied by the angular velocity, ω, of the drive sheave 105, i.e. PM=τω. The angular velocity ω for the run profile can be calculated based on the speed of the elevator car 101 during the run profile and the radius of the drive sheave 105. The power required by the drive unit 109 during the main part of the run profile can therefore be estimated based on the product of the torque measured during the initial phase of the run profile and an expected angular velocity based on the target constant speed of the elevator car 101 set in the run profile. The estimated power required by the drive unit 109 is thus extrapolated for the remainder of the run based on the predetermined run profile parameters and the measured torque in the initial phase to determine a total predicted power demand.

The total predicted power demand is then compared to the available power. If the total predicted power demand is greater than the available power, the parameters of the predetermined run profile are adjusted.

As in the example shown in FIG. 5, power is provided to the elevator system 100 by the single-phase power supply 115 alone, i.e. the battery 117 is unavailable. Because of this, only 2 kW±10% of power is available to the drive unit 109 of the elevator system 100 in the example shown in FIG. 6.

It can be seen that, when the dynamic run profile is employed, the elevator car 101 is caused to move, in the constant speed phase of the run profile, at between 1000 mms−1 and 140 mms−1 depending on the load in the elevator car 101. The dynamic run profile can be seen to have been adapted such that increased speeds are achieved when compared to the quasi-static profile shown in FIG. 5 for car loads between 30% and 90% of the maximum load, without the power consumed by the elevator system 100 exceeding the available power from the single-phase power supply 115.

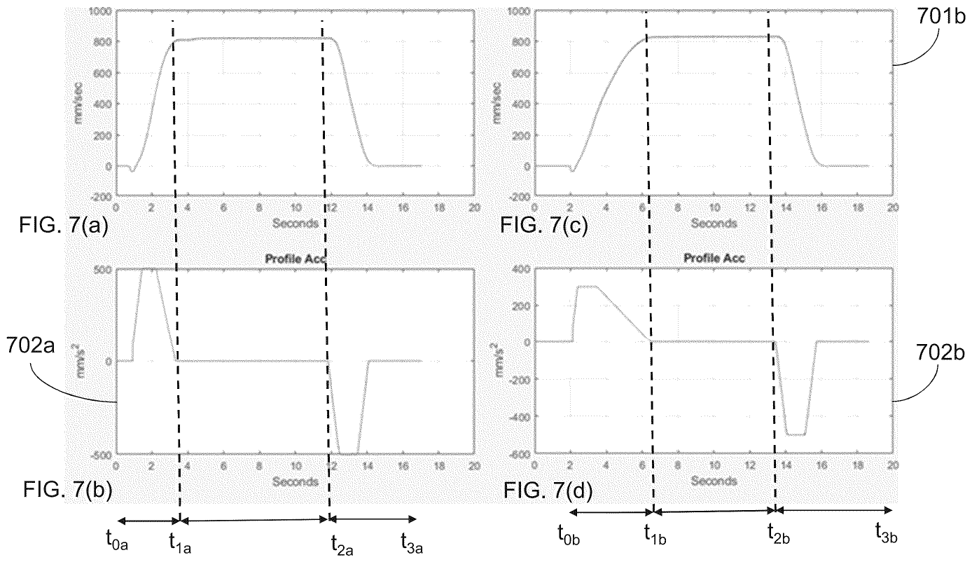

An example of the adjustment of run profile parameters in a reduced power scenario is illustrated in FIGS. 7(a)-7(d), which shows changes to the run profile for an elevator car 101 with maximum load.

The plots in FIGS. 7(a) and 7(b) show the speed and acceleration, respectively, of an elevator car 101 implementing a ‘standard’ (e.g. unadjusted) predetermined run profile with maximum car load and full power (10 kW±10%) available from the battery 117 and single-phase power supply 115.

The unadjusted run profile can be seen to comprise an initial phase, between t0a and t1a, in which the elevator car 101 accelerates from a stationary position at a departure landing to a speed of 800 mms−1, followed by a constant speed phase, between t1a and t2a, in which the elevator car 101 continues to move at 800 mms−1. Finally, the run profile comprises a deceleration phase, between t2a and t3a, in which the speed of the elevator car 101 is reduced to zero as it arrives at a destination landing.

The plots in FIGS. 7(c) and 7(d) show the speed and acceleration, respectively, of an elevator car 101 with maximum car load in the case that only power from the battery 117 is available, i.e. in which there is only 8 kW±10% of available power. In response to the reduction in available power, the run profile is adjusted according to the dynamic profile described above in relation to FIG. 6.

It can be seen in FIG. 7(d) that when the dynamic profile is applied, the maximum acceleration in the initial phase between t0b and t1b is reduced compared to the full power case shown in FIG. 7(b) from 500 mms−2 to 300 mms−2, and the deceleration from maximum acceleration is extended over time, i.e. the first jerk-out phase of the run profile is extended in response to the amount of available power being reduced. The jerk-out of acceleration is the most power-intensive part of the run profile, and by extending its duration the power consumption of the drive unit 109 can be significantly reduced.

As a result of the adjustment of the acceleration and jerk parameters of the run profile, the speed of the elevator car 101 can be seen to increase more slowly than in the case that both the battery 117 and the single-phase power supply 115 are fully functional, and the duration of the constant speed phase of the run profile between t1b and t2b can also be seen to be reduced. However, as can be seen in FIG. 7(c), despite only battery power being available, the elevator car 101 is still able to reach the same constant speed as is achieved when both the battery 117 and single-phase power supply 115 are available (as shown in plots 701a, 702a) due to the adjusted run profile parameters, and no emergency stopping operation is required, even at maximum car load.

Thus, by adjusting the run profile parameters of the elevator car 101 in response to a predicted power demand for the drive unit 109, e.g. by extending the duration of the first jerk-out phase based on the measured current through the motor 111 being greater than the available power, the elevator system 100 may continue to run effectively even when the single-phase power supply 115 is unavailable. As can be seen in FIG. 7, the adjustment of the run profile parameters allows reasonable flight times to be achieved even when the maximum car load is present. Predicting the power requirements of the drive unit 109 based on measurements of current through the motor 111 performed both while the elevator car 101 is stationary, as well as during an initial phase of the run profile, thus ensures that the drive unit 109 will stay within the available power limits despite reduced power availability and the load in the elevator car 101.

It will be appreciated by those skilled in the art that the present disclosure has been illustrated by describing one or more specific examples thereof, but is not limited to these examples; many variations and modifications are possible, within the scope of the accompanying claims.

What is claimed is:

1. An elevator system (100) comprising;
an elevator car (101); and
a drive unit (109) comprising:
a drive sheave (105) connected to the elevator car (101) by a tension member (103); and
a motor (111) arranged to rotate the drive sheave (105) so as to the move the elevator car (101) according to a predetermined run profile;
wherein the elevator system (100) further comprises:
one or more power sources (115; 117) for providing power to the drive unit (109);
a current sensor (113) arranged to measure a current through the motor (111) representative of a torque applied by the motor (111) to the drive sheave (105); and
a controller (123) configured to:
cause the current sensor (113) to measure the current through the motor (111), while the elevator car (101) is held stationary at the landing by the motor (111) and/or during an initial phase of the predetermined run profile;
determine a predicted power demand for the drive unit (109) based on the measured current and one or more parameters of the predetermined run profile;
determine an available power from the one or more power sources (115; 117);
determine whether the predicted power demand is greater than the available power from the one or more power sources (115; 117); and
if the predicted power demand is greater than the available power from the one or more power sources (115; 117), adjust one or more parameters of the predetermined run profile, while the elevator car (101) is held stationary at the landing by the motor (111) and/or during the initial phase.

2. The elevator system (100) of claim 1, wherein the controller (123) is configured to cause the current sensor (113) to measure the current through the motor (111) during the initial phase of the predetermined run profile before the elevator car (101) reaches a constant target speed.

3. The elevator system (100) of claim 2, wherein the controller (123) is configured to cause the current sensor (113) to measure the current through the motor (111) during an initial acceleration of the elevator car (101) away from the landing.

4. The elevator system (100) of claim 2, wherein the controller (123) is configured to cause the current sensor (113) to measure the current through the motor (111) during a reducing acceleration of the elevator car (101) as it approaches the constant target speed.

5. The elevator system (100) of claim 1, wherein the one or more power sources (115; 117) comprises a connection to an electrical grid.

6. The elevator system (100) of claim 1, wherein the one or more power sources (115; 117) comprises a battery (117).

7. The elevator system (100) of claim 1, wherein the controller (123) is further configured to determine whether the available power from the one or more power sources (115; 117) has reduced by more than a threshold value.

8. The elevator system (100) of claim 7, wherein, in response to determining that the available power from the one or more power sources has reduced by more than a threshold value, the controller (123) is configured to adjust one or more parameters of the predetermined run profile and cause the elevator car (101) to move according to the adjusted run profile.

9. The elevator system (100) of claim 1, wherein the one or more parameters include: a constant target speed of the elevator car, a maximum acceleration of the elevator car, and a maximum jerk of the elevator car.

10. The elevator system (100) of claim 1, wherein the controller (123) is configured to adjust the constant target speed of the elevator car (101) while the elevator car (101) is moving during the initial phase.

11. The elevator system (100) of claim 1, wherein the controller (123) is configured to adjust the maximum acceleration of the elevator car (101) while the elevator car (101) is held stationary at the landing by the motor (111) and/or while the elevator car (101) is moving during the initial phase.

12. The elevator system (100) of claim 1, wherein the controller (123) is configured to adjust the maximum jerk of the elevator car (101) while the elevator car (101) is held stationary at the landing by the motor (111) and/or while the elevator car (101) is moving during the initial phase.

13. The elevator system (100) of claim 1, wherein the controller (123) is configured to adjust the maximum acceleration and/or maximum jerk of the elevator car (101) at a first time during the initial phase and to subsequently adjust the constant target speed of the elevator car (101) at a second, later time during the initial phase.

14. A method of operating an elevator system (100) comprising an elevator car (101) and a drive unit (109), the method comprising:
measuring a current through a motor (111) of the drive unit (109) using a current sensor (113) while the elevator car (101) is held stationary at the landing by the motor (111) and/or during an initial phase of the predetermined run profile, wherein the current is representative of a torque applied by the motor (111) to a drive sheave (102) connected to the elevator car (101) by a tension member (104);
determining a predicted power demand for the drive unit (109) based on the measured current and one or more parameters of a predetermined run profile for the elevator car (101);
determining an available power from the one or more power sources (115; 117);
determining whether the predicted power demand is greater than the available power from the one or more power sources (115; 117); and
if the predicted power demand is greater than the available power from the one or more power sources (115, 117), adjusting one or more parameters of the predetermined run profile while the elevator car (101) is held stationary at the landing by the motor (111) and/or during the initial phase.

15. The method of claim 14, comprising measuring the current through a motor (111) of the drive unit (109) during the initial phase of the predetermined run profile before the elevator car (101) reaches a constant target speed.
